(19) United States
(12) Patent Application Publication
(10) Pub. No.: US 2005/0255913 A1
(43) Pub. Date: Nov. 17, 2005

(54) Collectible display device

(75) Inventor: Ronald S. Cok, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/844,914

(22) Filed: May 13, 2004

(51) Int. Cl. G06F 19/00; A63F 13/00

(52) U.S. Cl. 463/31

(57) ABSTRACT

Collectible display devices and methods for operating the same are provided. The collectible display device has a display; a non-volatile memory adapted to store at least one set of pre-determined character information depicting a character, said character information including character data and character image content; a communication circuit adapted to receive predetermined character information; and a display controller adapted to receive pre-determined character information from the communication circuit, to store the received pre-determined character information in the non-volatile memory so that changes cannot be made to the pre-determined character information without external authorization and to cause the display to present at least one image based upon the character information.

### FIELD OF THE INVENTION

This invention relates generally to a display device and, more particularly, to low-cost, collectible display devices having pre-defined content.

### BACKGROUND OF THE INVENTION

Cards with information about celebrity sports characters are popular collectible items for sports aficionados. For example, baseball cards have been used for many years to entertain baseball fans. These cards are typically printed annually with static pictures of characters and performance statistics provided for each player during each year. Individually each card has a modest value, however, cards from a prominent player's first season and complete sets of player cards for selected teams and complete sets of player cards that include every card made for a player during the player's career are of particular value. Enthusiasts often build such sets by purchasing cards and/or trading cards.

Such cards only contain a limited amount of information: the information that can be printed thereon. Typically this information includes a static two-dimensional player image one side of the card and a static two-dimensional print out of player statistics and other player information on the other side. In some instances it has been known to make sports cards that have a lenticular screen on one side that enables an image to be recorded on the card that has apparent depth or that provides an action image with a sequence of images that appear to show the character in motion. Such cards are not adapted to present audio information or to present motion video information. Further, such cards are not adapted so that information recorded in association with the cards can be updated.

More complex collectible playing systems are known. For example, U.S. Pat. No. 6,634,949 B1 entitled “Multi-Media Collectible Play System” issued on Oct. 21, 2003 describes a multi-media collectible play system having a number of play elements situated in a variety of play environments or play media. The play elements are linked to a common record of participant performance, progress, character attributes, etc. The participant's performance in the play elements determines the play elements to which the participant may proceed as well as the play parameters of the play element in which the participant is currently involved. The play elements are thus interlinked to define a sequence or path network along which the participant advances. By advancing through the play elements the participant carries out a plot, story, theme, etc. that attaches a significance to the successful completion of a given play element or elements. Also disclosed is a variety of play elements suitable for use in the system, an example of a plot or theme that may be carried out by the system, and a send/receive radio frequency network that may be used to track play participants in a play center. However, such a system is extremely complex to implement, is expensive, and does not conform to rules for more common card-based games currently popular with children and young adults. Importantly, such a system typically does not support the collection aspects of currently popular collectibles.

A single element entertainment device commonly known as the Tamagotchi was introduced in Japan by the Bandai Corporation in 1997. The Tamagotchi device is a key-chain computer game. In an initial iteration of this device, the game starts when a virtual egg on a display screen hatches and a virtual chicken is born. The owner then uses a user interface to effectively raise the chicken by performing activities such as feeding, cleaning up after it, and playing with it. Like a real pet, constant daily interaction is necessary to ensure proper growth and development. A failure to provide such interaction has consequences including, in extreme cases, the virtual death of the virtual chicken. While popular in its genre, such Tamagotchi games lack the celebrity connection that is popular in the card based collections and further the form factor and the constant interaction required by such devices typically prevents users from maintaining large collections of such devices.

A large variety of other more conventional programmable video game devices are well known. For example, U.S. Pat. No. 6,544,126 B2 entitled “Portable Game Machine With Download Capability” issued Apr. 8, 2003 describes a portable handheld game machine that includes a capability to download and execute code from a source such as another game machine. However, such games are still quite large and are relatively expensive and complex. Further, such game machines typically do not support collection aspects of popular card based items.

Thus, there remains a need for a collectible display device and system that permit a user to store and exchange a variety of information relevant to one or more characters and to cooperate with the holders of other devices but that has a cost structure and form factor that facilitates storage of collections of such display devices.

### SUMMARY OF THE INVENTION

In one aspect of the invention, a collectible display device is provided. The collectible display device has a display; a non-volatile memory adapted to store at least one set of pre-determined character information depicting a character, said character information including character data and character image content; a communication circuit adapted to receive predetermined character information; and a display controller adapted to receive pre-determined character information from the communication circuit, to store the received pre-determined character information in the non-volatile memory so that changes cannot be made to the pre-determined character information without external authorization and to cause the display to present at least one image based upon the character information.

In another aspect of the invention, a collectible display system comprising a plurality of collectible display devices each collectible display device having at least: a display capable of forming images; and a non-volatile memory having predetermined character data stored therein; at least one source of character image content; at least one source of character data; a communication circuit adapted to exchange data between the plurality of collectible display devices; and a display controller adapted to use the predetermined character data to determine character data for each of the plurality of collectible display devices, to select character image content from the source of character image content for presentation on each collectible display device based upon the character data determined for that collectible display device and to cause the character image content selected for each collectible display device to be presented on the display associated with that collectible display device, wherein the display controller further causes the character data determined for each collectible display device to be stored in the non-volatile memory for that device so that changes cannot be made to the determined character data without external authorization.

In another aspect of the invention, a collectible display device comprising a display; a non-volatile memory having pre-determined character information stored therein with the predetermined character information including character data and at least one character image; a communication circuit adapted to receive additional character information; and a display controller adapted to receive character data and image content from the communication circuit and to cause the display to present the character data; wherein the display controller is further adapted to store additional received character information in the non-volatile memory so that changes cannot be made to the character information without authorization.

In yet another aspect of the invention, a method is provided for operating a collectible display device having predetermined character data and image content stored therein, the method comprising the steps of: detecting a source of character information having character data and character image content; receiving character information including character data and character image content from the source; and storing the received character information so that once stored, the received character information cannot be adjusted without external authorization.

### BRIEF DESCRIPTION OF THE DRAWINGS

FIG. 1 is a schematic diagram of a collectible display according to an embodiment of the present invention;

FIG. 2 is a schematic diagram showing one embodiment of a collectible display having an efficient component arrangement;

FIG. 3 shows one embodiment of a method for operating a programming system such as a kiosk, internet access terminal, personal computer or other programmable device to provide such information to a collectible display device;

FIG. 4 shows a block diagram depicting a display device and a programming system joined for interaction;

FIG. 5 illustrates one example of a pair of collectible display devices used in combination; and

FIG. 6 is an illustration of another embodiment of a collectible display system in accordance with the present invention.

### DETAILED DESCRIPTION OF THE INVENTION

In accordance with various aspects of the present invention, a collectible display and collectible display system suitable for use in collectible activities such as collecting and other forms of social interaction are provided.

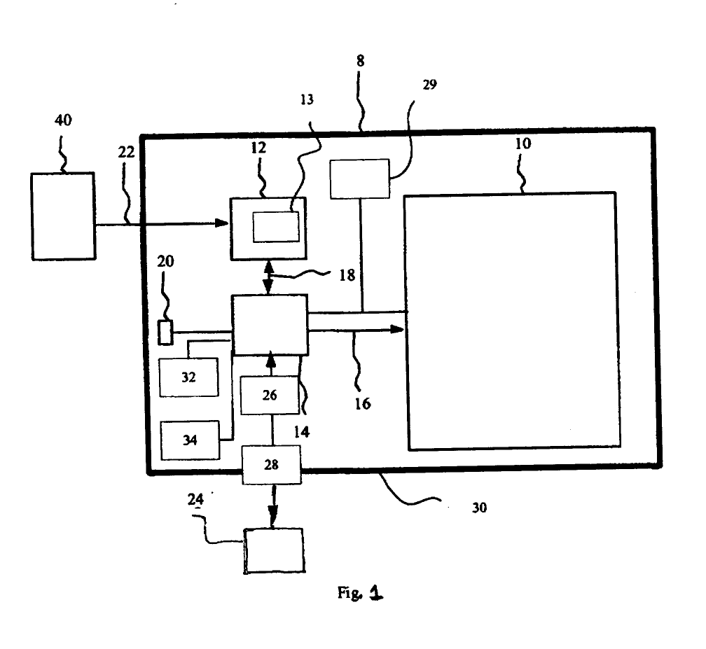

Referring to FIG. 1, one embodiment of a collectible display 8 according to the invention is shown. In this embodiment, collectible display device 8 has a display 10, a non-volatile memory 12, a switch 20 for turning the device on or off, and a display controller 14 for reading the non-volatile memory 12 and displaying image content on display 10 based upon data obtained from non-volatile memory 12. The embodiment of display controller 14 shown in FIG. 1, includes a display interface 16 to display 10 and a memory interface 18 to non-volatile memory 12. The display controller 14 includes a communication circuit 26 for exchanging data with a similar collectible display device 8. Non-volatile memory 12 can include multiple components some of which can include volatile read-write memory (e.g. RAM) along with non-volatile memories, such as a read-only memory (e.g. ROM), or a non-volatile read-write memory (e.g. Flash Memory). Such multiple components can comprise separate structures or can be manufactured as an integrated circuit.

As will be described in greater detail below, at least a portion of display memory 12 can comprise a locking memory 13. Locking memory 13 can be a memory that is of a type will restrict the ability of a user of collectible display device 8 to modify the data stored therein. In one embodiment, locking memory 13 comprises a conventional non-volatile programmable read-only memory or a write-once memory. In this embodiment, data can be written to the programmable read-only memory or to the write-once memory but, once written, such data cannot be erased, deleted or modified. In this way, the read-only memory provides a reliable record of data stored therein.

In another embodiment, locking memory 13 comprises a non-volatile read-write memory having a memory interface 18 that permits data to be read or written only where appropriate authorizations or codes are supplied to the write-once memory. In this embodiment, data written to locking memory 13 can be associated with collectible display system 8 in a manner that can be modified but only with appropriate authorizations.

In still another embodiment, locking memory 13 can comprise a conventional non-volatile read-write memory having data stored therein in an encoded or encrypted fashion that is readable by display controller 14, but that is difficult for a conventional user of collectible display device 8 to understand or reprogram properly. Various well-known encoding or encryption schemes can be used for this purpose.

Display controller 14 can be a programmable display controller such as a microprocessor, microcontroller or programmable analog device. Alternatively display controller 14 can be of a type that is not programmable and in this alternative can include a memory interface and display driver. Such a non-programmable embodiment of display controller 14 can be implemented for example with a state machine or hard-wired logic circuit. Such an alternative construction provides a low-cost and low-power display controller 14 that can perform the functions described herein.

An external interface 22 is optionally provided. In the embodiment shown in FIG. 1, external interface 22 is accessible to external circuitry 40. When interface 22 is connected to external circuitry 40, for example, by way of a Universal Serial Bus connector, external interface 22 can be used to transmit and receive character data image content and/or interaction data from external circuitry 40 and stores this image content in non-volatile memory 12 and/or in locking memory 13 as appropriate. Alternative embodiments of external interface 22 can be provided, for example, external interface 22 can be adapted to engage a networked interface to a computer network or the Internet. External interface 22 can be used to set up and/or program non-volatile memory 12 with image content and character data and for programming display controller 14.

Communication circuit 26 is provided for enabling communication between collectible display device 8 and other collectible display devices. Communication circuit 26 can take a variety of forms, for example it can comprise any of a transmitter, receiver, transceiver, transcoder, or any other device adapted to encode and decode data for exchange during communication with other devices and, where appropriate, a communication access port 28 that provides access to data circuits and systems 24 that are external to body 30 of collectible display device 8 to facilitate such communication. Communication circuit 26 and access port 28 are co-designed to facilitate communications. Communication circuit 26 can be implemented in a variety of ways, including wirelessly, for example using radio frequency, optical or other known wireless communication circuits and systems to establish a wireless communication path. Examples of such wireless communication systems include but are and not limited to circuits and systems that communicate in ways that that conform to wireless communication standards such as the so-called “Wi-Fi” and so-called “Bluetooth” standards established and described at Institute of Electrical and Electronic Engineers standards 802.11a and 802.11b. Alternatively communication circuit 26 can be adapted to communicate using infrared technology using protocols established by the infrared data association (IrDA). Such protocols include, but are not limited to the serial infrared protocol (SIR) and other protocols developed by the IrDA.

In such wireless embodiments, access port 28 provides, for example, an antenna for use in radio frequency communication, or light transmitting and sensing areas adapted to optically exchange data, such as an infrared or other optical interface system known in the art.

In other embodiments, communication circuit 26 can be adapted for communication with external data circuits and systems 24 such as other collectible display devices using a direct electrical or optical path between access port 28 of the collectible display device 8 and another collectible display device. In such embodiments access port 28 can comprise, for example, a serial or parallel port, or a networked interface to a computer network or the Internet. One example embodiment of a communication circuit of this type is a communication circuit 26 that is adapted to enable communication using hardware and protocols that are consistent with the EIA/TIA-232-E standard entitled “Interface Between Data Terminal Equipment and Data Circuit-Termination Equipment Employing Serial Binary Data Interchange” prepared by the Electronic Industry Association and the Telecommunications Industry Association. Other example embodiments of a communication circuit of this type include circuits and systems that conform with the standards set for the universal serial bus standard, and the IEEE 1394 (so-called “Firewire”) standard. Communication circuit 26 can also comprise circuits and systems that comply with other standards or that comply with proprietary standards.

In still another embodiment, communication circuit 26 can be adapted to exchange data with a portable memory device such as a removable memory card that can be held by access port 28 of collectible display device 8 and moved to an access port 28 of another collectible display device so that data can be exchanged using the removable memory card as an intermediary.

In still another alternative embodiment, a direct link can be established using optional external interface 22 in addition to or in place of access port 28.

In the embodiment shown in FIG. 1, collectible display device 8 comprises a power cell 29, for example a battery, that provides power to display 10, non-volatile memory 12, display controller 14, display interface 16, memory interface 18, switch 20 and/or external interface 22, communication circuit 26, and any other components of display device 8. In certain embodiments, power can be supplied to these components of collectible display device 8 by way of external interface 22 and/or access port 28.

In the embodiment of FIG. 1, collectible display device 8 also comprises an optional user input system 32 to enable a user to provide input to display controller 14 that display controller 14 can use in operating display device 8. User input system 32 can comprise, for example, a touch screen input, a touch pad input, a 4-way switch, a 5-way switch, a 6-way switch, an 8-way switch, or any other multi-way switch structure, a stylus system, a trackball system, a joystick system, a voice recognition system, a gesture recognition system or other such systems.

Display controller 14 can determine interaction data, execute trades, or perform other actions based upon user input. As used herein, interaction data can comprise any data that is transferred to or from a collectible display device 8. Examples of interaction data will be described below. However, in general, interaction data can comprise character data, character images, data regarding the character, action data indicating action taken by a user of interactive display device 8 using user input system 32, video signals, or any other audio, visual or textual information. Other examples of interaction data comprise any form of data that describes other characters or groups of characters, relationships between characters, or groups of characters, interactions between groups of characters, and background or other graphic imagery that can be displayed using a display device 8. Interaction data can be used for purposes such as cooperative interaction and information transfer, sharing authentication and recordkeeping. Interaction data can also be used for a wide variety of other purposes. In another example, described below, the interaction data is used as a form of currency that can be acquired during interactions between multiple collectible display devices and used to acquire new characters. The interaction data can also be used to govern interactions between such characters, and for such other purposes as will be described herein.

An optional audio system 34 can be incorporated into collectible display device 8 to convert an audio signals stored in non-volatile memory 12 into an audible form and, optionally, to record audio signals provided by a user. Audio signals can be included as part of interaction data as will be described in greater detail below. Efficient, low cost, audio playback methods are well known and enabling devices are commercially available.

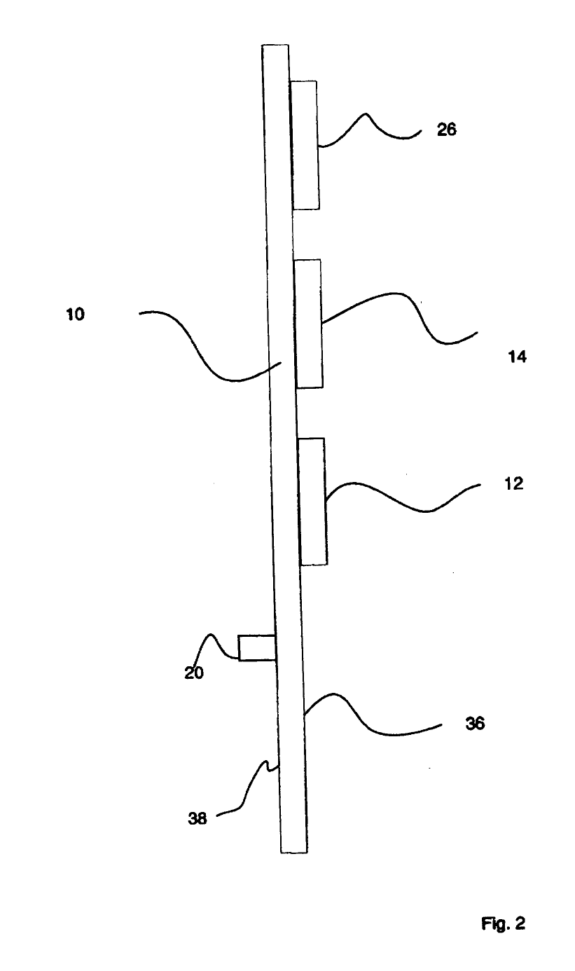

It is useful to minimize the thickness of collectible display device 8 to mimic, as closely as possible, conventional printed communications for example, cards, photographic prints, paper media and the like. To this end, the components such as non-volatile memory 12, display controller 14, and switch 20 that are used in various embodiments of collectible display system 8 can be assembled on a back 36 or face 38 of display 10 as shown in the embodiment shown in FIG. 2. In particular, it may be useful to have non-volatile memory 12, display controller 14 and communication circuit 26 affixed to the back of the display 10 and switch 20 to be affixed to a face 38 of display 10 or otherwise positioned so that it can be conveniently actuated by a user of collectible display device 8. In this way, collectible display device 8 can take a form that is consistent with the form of a conventional collectible/trading card such as a baseball card, a football card, or the like, a collectible/trading/gaming card of the type that currently carries images of celebrity characters thereon, and/or other forms of collectible memorabilia. Collectible display device 8 can also be incorporated onto rigid or flexible and/or foldable substrates to provide a wide variety of items.

Display controller 14 and non-volatile memory 12 can be combined into a single integrated circuit and/or potted together, for example, using a protective resin to provide a small, low-cost circuit. Any protective material applied to the circuitry can be applied.

Each display device 8 has predetermined character information stored therein. The character information includes character data and character image content. The character data can include any of such as data defining a character's identity, a character's name, a character's capabilities, a character's voice imprint, a character's statistics and the like. The character image data can comprise any still or motion video sequence or viewable graphic symbol or graphic animation or any other image, text or graphic representation that can be presented on display 10. Optionally, interaction data can also be provided.

Character information and/or interaction data can be written into locking memory 13 before assembly of collectible display device 8 or after assembly using external circuitry 40. Whenever this is done, the step of recording such character information and/or interaction data to the collectible display device for a first time is described herein as recording predetermined character data and/or predetermined interaction data in the collectible display device.

Optionally, a purchaser of collectible display device 8 can personalize the character information and/or interaction data, for example by entering personalization data through the external interface 22, or transmitting this information through communication circuit 26. Such personalization data can include, for example, personal names and character appearance preference, security or access codes, audio, and video signals. Personalization data can also be entered using user input system 32 of collectible display device 8. In one embodiment, display controller 14 requires an operator to provide personalization data through user input system 32 as a part of an initial set-up phase of operation of collectible display device 8.

According to one embodiment of the present invention, a plurality of collectible display devices 8 are provided to a group of collectors. Each collectible display device 8 has predetermined character information defining a character identity. The character identity is defined in part by a character name, attributes, statistics and, in part, by one or more images, an image sequence, or a stream of image information or any other form of video or graphic content relevant to the character. For example, famous athletes, movie stars, and historical or political figures can be employed. Individual members of sporting teams or film casts can be employed. The plurality of collectible display devices can, optionally, have character data that associates the character with a group such as an aforementioned team or cast. In such an embodiment, each character has an individual identity and a group identity.

Each collectible display device 8 can have a display controller 14 that is adapted to collect information over the course over a period of time or during a sequence of events or interactions and to provide a collection of images, information and/or audio signals that reflect character activity and interactions, said collection being incorporated into the character information and stored accordingly.

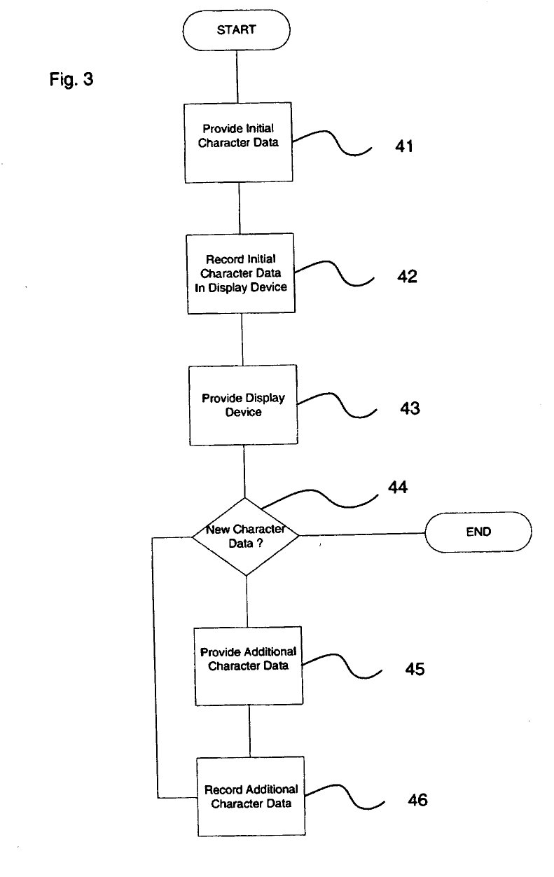

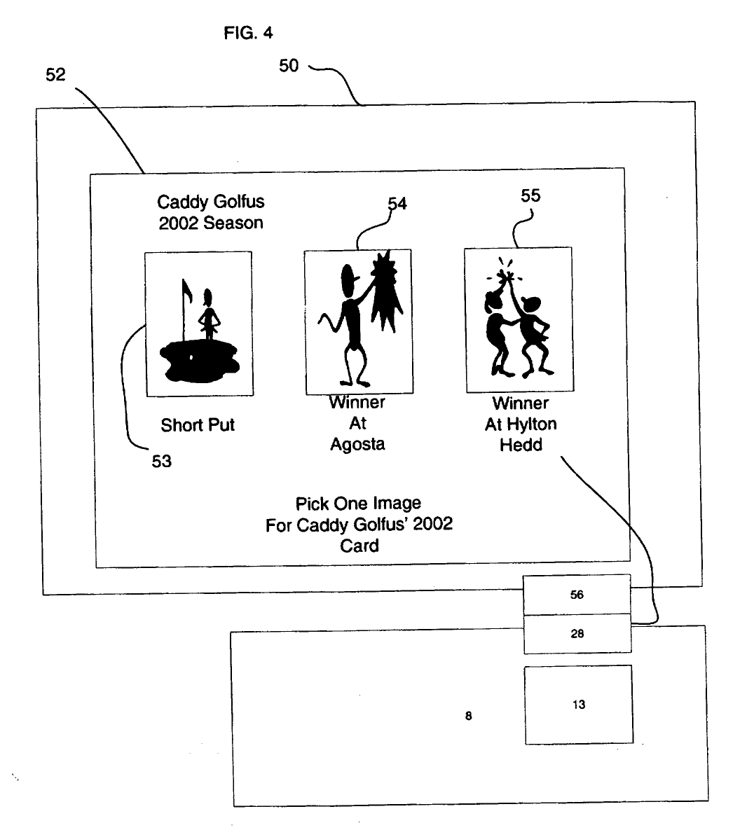

FIG. 3 shows one embodiment of a method for operating a programming system such as a kiosk, internet access terminal, personal computer or other programmable device to provide such information to a collectible display device 8. FIG. 4 shows a block diagram depicting a display 8 and a programming system 50 joined for interaction. As is shown in the embodiment of FIG. 3, initial or predetermined character information as described generally above is provided for at least one character (step 41). The predetermined character information can include character data, character image content and can also include information intended to indicate the authenticity of the information recorded in the display.

The predetermined character information is recorded in locking memory 13 (step 42). This is done in a manner that makes it difficult if not impossible for an unauthorized person to alter this information. For example, the predetermined character information can be recorded using a form of encodement or can be recorded in a locking memory 13. In the embodiment shown, collectible display device 8 is shown connected to programming system 50 by joining a terminal 56 of programming system 50 to access port 28 of collectible display device 8. However, any other method described herein for providing data communication circuit 24 can be used.

Collectible display device 8 is then provided to a user (step 43). Typically, this is done by selling the collectible display device 8 to a user however, this is not necessary and in some business models the collectible display device 8 can be provided to a user without a sale. In other embodiments, the collectible display device 8 is provided to the user before the initial character information is recorded therein.

When new, adjusted and/or supplemental character information becomes available, (step 44) such as when a character has completed an adventure or a sports character has completed a season, display controller 14 can determine that such character information is available and (i.e. season 2 information) request this character information (step 45). Alternatively, a user can use user interface 32 to request such information.

This new, adjusted and/or supplemental character information is then sold or otherwise made available and recorded in the locking memory 13 in addition to any previously stored information (step 46). In this way, a user can build a collection of information about a single character without having to build a collection of separate cards. The user can selectively cause the collectible display device 8 to present initial information and/or additional character information as desired by the user. For example, in cases where a character is a sports figure or other figure that has information recorded in installments such as annual performance measures or statistics or seasonal image content highlights, the user can use user interface 32 to select a desired installment.

In one optional embodiment of the present invention, the steps of providing predetermined character information (step 41) to the collectible display device 8 and/or providing additional character data (step 45) comprises the optional step of presenting a user of a collectible display device 8 with more than one option of initial character information or additional character information to be incorporated into collectible display device 8. For example, as is shown in FIG. 4, a user at a kiosk 50 is provided with a display screen 52 that identifies the character that the user wishes to associate with collectible display device 8 and also provides three different sets of initial character information shown in this embodiment as three different pictures of the character, and in this example the user selects image 55 Winner at Hylton Hedd. Accordingly, the image 54 of the character Caddy Golfus winning at Hylton Hedd is stored in locking memory 13 in association with any other information relevant the 2002 season for Caddy Golfus.

This process can be repeated each time that additional character information is to be provided to collectible display device 8. Importantly, this process allows the user to select from among memorable performances that have occurred during a year. In one embodiment of the invention, the performances that are recorded in a collectible display device 8 are fixed once that they have been recorded in a display device or at some other convenient time. The selection of the user can be compared to the selections that are made by the character or by other users of other collectible display devices and over time the number of collectible display devices 8 that have exact combinations of video or still images that correspond to the preferred combinations selected by the player or by other users drops significantly.

TABLE I
shows an example of this.

| Caddy | Golfus' Favorites | Display Device 1 | Display Device 2 |
|---|---|---|---|
| 1998 | Shadow Lake | Oak Hills | Shadow Lake |
| 1999 | Buck Open | Agosta | Buck Open |
| 2000 | Agosta | Agosta | Agosta |
| 2001 | St. Andy's | Agosta | St. Andy's |
| 2002 | Hylton Hedd | St. Andy's | Hylton Hedd |

Accordingly, in this example collectible display device 8a has selected a combination of images that has only limited correspondence with respect to the combination of images selected by Caddy Golfus, while collectible display device 8b has an exact match. Accordingly, collectible display device 8b will have a higher value for collectors.

Each collectible display device 8 can be adapted to contain a serial number or some other unique and non-modifiable identifier, is provided to programming system 50 during programming. Programming system 50, in turn, records information documenting what character information, has been recorded in association with collectible display device 8. This record is not necessarily made accessible to the holder of the device but is instead used for integrity checking at a later time. This record can be used to authenticate a collectible display device 8 that has a preferred combination of content to prevent fraud. Further, in cases where a collectible display device e.g. collectible display device 8a is damaged, fails, or is lost this record can be used to help generate an authorized replacement for the damaged, failed or lost collectible display device 8a.

In one embodiment of the invention, character information or other information stored in locking memory 13 can only be altered, changed or supplemented by a retail vendor, wholesale vendor or an online vendor of the interactive display device 8. This allows a user to change character data selections only under authorized conditions and ensures that a record of such changes can be made. Accordingly in such an embodiment, a user of display device 8a can elect to change the selection of Winning at Hylton Hedd to the selection of Winning at Agosta however, this may require an additional payment and may require the storage of data that can be used to indicate that the card has been altered for the 2002 season.

In another embodiment of the invention, display devices such as 8a and 8b can be adapted to allow users of display devices 8a and 8b to exchange character data without intervention by a vendor. This can be done, for example, by detecting user input by a user of collectible display device 8a requesting that collectible display device 8a exchange the predetermined character data for the character data stored in collectible display device 8a. Where this is done, both collectible display devices 8a and 8b can be adapted to generate an authorization signal in response to an exchange request and to execute such an exchange request only when an authorization is received from the other collectible display device.

Collectible display device 8 can also be used to store collections of characters and character information and to enable a user to observe any of character information for any character. In one such embodiment, a collectible display device 8 is adapted to receive character information for individual players on a team during a particular season. This can be done in a variety of ways such as by purchasing or otherwise obtaining character information from a vendor.

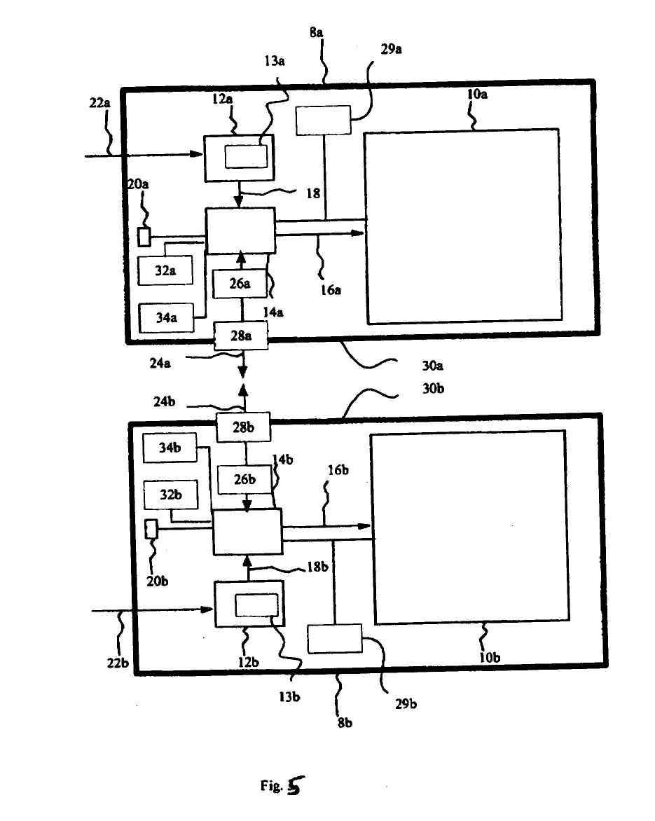

Collectible display devices 8 can be used in combination to trade and exchange character information. As is shown in FIG. 5, this can be done by combining display device 8a in a paired relationship with another display device 8b. Each pair exchanges character data through communication circuits 26a and 26b. Character data can include, but is not limited to, character identification data, character attributes data, character historical data, and image content. Display controllers 14a and 14b can then use the exchanged character data and image content stored in locking memory 13 or other graphic content stored in memory 12 to generate an entertaining image, images, or image sequence, and optionally an audio sequence representing the characters or, interaction or collaboration of the characters on each of displays 10a and 10b. In this way, characters can be exchanged and image sequences enabled. The character interaction can be dependent on some degree of chance or on information supplied by the operator of collectible display devices 8a and 8b in response to questions or other opportunities for providing user input by way of user input systems 32a and 32b so that one operator may be lucky while another may be more knowledgeable, thereby influencing the nature of the interaction.

For example, a group of collectible display devices 8 may be provided, with each collectible display device having predetermined character information about an athlete on a specific, common team. Purchasers of the display devices 8 then cause their display devices 8 to interact with each other. Each interaction exchanges character data and image content between each display device. In this example, the character information can include the athlete's identity, performance record, image, and an image sequence of a notable athletic achievement. Each interaction allows a user to add to a collection of characters for which is stored in their respective display device 8.

A user can exchange or share characters with various member of the group, to obtain a complete set of character information for each character making up an entire group. Once the complete set is acquired, display device may play back a famous achievement of the team, rather than of character on the team alone. Collectors having complete team collections may then interact with other collectors having complete team collections to reenact games or play fantasy games. In another embodiment, collectors may create fantasy teams comprising a collection of preferred player characters. The teams may interact with each other using the collectible display devices 8 to conduct fantasy games and/or tournaments.

In one embodiment of the invention, each collectible display device 8 can be associated with interaction data comprising interaction points. During an interaction, a collectible display device that wins in the interaction can acquire interaction points from a collectible display device that loses. These interaction points can then be used by the holder of the collectible display device 8 that has acquired the interaction points to purchase new characters or to purchase additional or alternative character information such as image content from a vendor such as a retailer, a retail kiosk, or an online or other retail establishment.

In any embodiment of collectible display device 8 having a locking memory 13, locking memory 13 can be used to store a protected record of information relevant to a character with which the collectible display device is associated. By storing such information in the locking memory 13, the character data associated with the card collectible display device may not be manipulated in a way detrimental to the reputation of the character, the integrity of character data selections made by a user can be preserved, and/or a record of interactions using the collectible display device 8 can be maintained.

In one embodiment of the invention, collectible display devices 8a and 8b are adapted to interact. In this regard, collectible display devices 8a and 8b can be joined, for example, by way of access ports 28a and 28b to enable interactions, as is shown in FIG. 5. As collectible display devices 8a and 8b undergo a series of interactions, the collection of characters stored in each collectible display device 8a and 8b increases. When, for example, a complete set of characters is acquired, a new set of characters may be pursued so that progressive levels of interaction may be enabled. Other character interaction data can be stored in locking memory 13, such as a record of characters that had previously been interacted with.

Collectible display devices 8 having different characters can be vended by vending machines, kiosks and the like. Different collectible display devices can be selected by a purchaser, each having different characters and that may be sold at different prices. Alternatively, groups of players may agree to establish a set of character data and image content and utilize a computer network and software to facilitate exchanges of relevant image content and other character data for their collectible display device 8. In certain embodiments, users can determine character data for use in a game by way of agreement among players and can enter these agreed upon limitations by way of user interface 32. In other embodiments, characters and interaction data associated with those characters can be purchased for example, a user of collectible display device 8 associated with one character can purchase a particular character from a vendor, kiosk or on-line retailer.

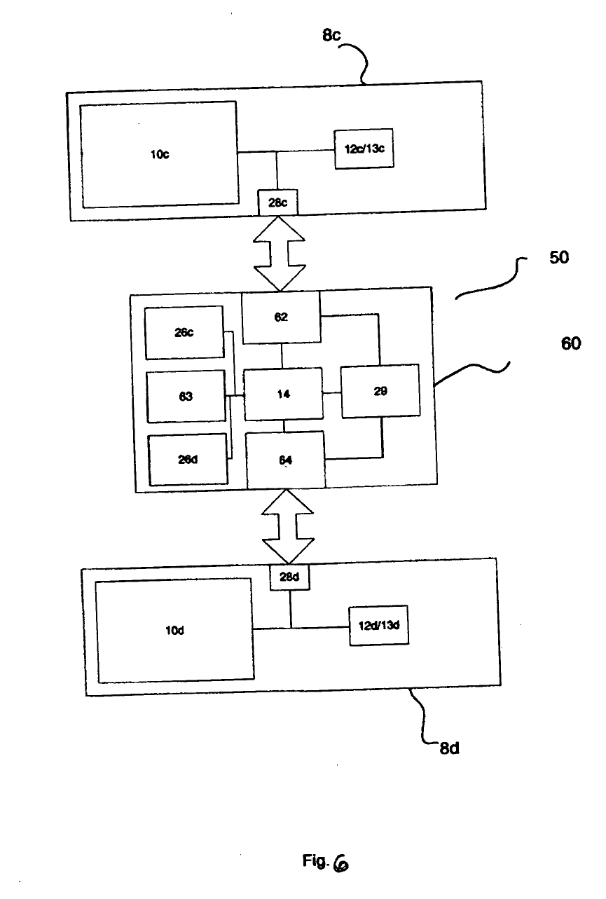

FIG. 6 shows yet another embodiment of the present invention. In this embodiment, a collectible display system 50 is provided having a plurality of collectible display devices 8c and 8d and an interface module 60 that joins collectible display devices 8c and 8d. In this embodiment, each collectible display device 8c and 8d incorporates respectively a display 10c and 10d, a memory 12c and 12d, and access ports 28c and 28d. Memories 12c and 12d store character information as described above and can comprise locking memories 13c and 13d for storing the character data. Interface module 60 comprises a display driver 14, and engagement ports 62 and 64 are each adapted to engage an access port 28c and 28d respectively to establish a direct electrical connection for communication therebetween.

In the embodiment shown in FIG. 4, interface module 60 comprises a source of power 29 that is capable of supplying power to operate interface module 60 as well as displays 10a and 10b and memories 12c, 12d, 13c and 13d as necessary.

During operation, collectible display devices 8c and 8d are connected to interaction module 60 by attaching access port 28a to engagement port 62 and by attaching access port 28b to engagement port 64. Such engagement establishes a direct data path between displays 10, memories 12c, 12d, 13c and 13d, and display driver 14. Display driver 14 obtains character information content from each of collectible display devices 8c and 8d using this data path. Upon receipt of such information, display driver 14 determines the nature of the interaction to occur between the collectible display devices 8c and 8d. Where appropriate, display driver 14 can then generate signals that cause either of display devices 8c or 8d to generate images or audio signals soliciting a user input. Such user input can be made using user input systems 26c and 26d provided as a part of interaction module 60.

Based upon the obtained interaction data and the user inputs display controller 14 can determine modified interaction data for each collectible display device 8c and 8d. Display controller 14 can then determine modified image content for presentation on display devices 8c and 8d. In the embodiment that is shown in FIG. 4, display controller 14 obtains character image content from each of locking memories 13a, and 13b based upon the interaction data and generates signals that cause each collectible display devices 8c and 8d to present an image that is appropriate for the modified interaction data. Accordingly, in this embodiment, a collectible display device can be provided that has a small shape and is low cost yet preserves the collectible functionality by moving certain systems and circuits that add cost to a collectible display device to interface module 60.

In a further embodiment, each of memories 12c and 12d can hold only character data having information that identifies the character and provides data for the character using the character data. Where this is done, interaction module 60 will be adapted to obtain character image content for each character. This can be done as shown in FIG. 5, by obtaining such content from a memory 63 with character image content and/or other information regarding the character stored therein. Memory 63 can be a component of interaction module 60 or it can be separate therefrom and joined thereto by way of a wired or wireless communication path. In one example of this type of the arrangement, the character data can comprise information that allows display driver 14 to obtain character image content from a memory 63 by way of a network such as the Internet. In this for example, the character data can comprise a World Wide Web address. Display driver 14 uses a World Wide Web address to obtain image content. Display driver 14 then uses the obtained image content to adjust the appearance of images presented on displays 10c or 10d as appropriate.

In yet another embodiment, interaction module 60 can comprise a conventional video game console or personal computer adapted to operate to create a video game environment. The character information in collectible display devices 8a and 8b can be used by such an embodiment of interaction module 60 as the basis for conducting a group, interaction or individual character interaction. In this regard, interaction module 60 can be adapted to present information regarding the interaction on a group display such as a television.

In still another embodiment, each of memories 12c and 12d can be adapted so that they contain only character data that uniquely identifies the characters associated with collectible display devices 8c and 8d respectively. In this embodiment, display driver 14 stores character image content and character data in memory 63 so that such data can be recalled using the character identification data. Accordingly, in this embodiment, the amount of data to be stored in collectible display devices 8c and 8d is minimal, further reducing the cost of a collectible display device 8c and 8d of this type.

In yet another embodiment, interaction module 60 can comprise a conventional video game console such as a console that is adapted to cooperate with a display such as a television, a video game system that uses hand held components, and/or a mobile or stationary personal computer system. In such an embodiment, either interaction module 60 or collectible display devices 8a and/or 8b are adapted to engage the interaction module 60 which interacts with the collectible display devices to create a video game or other interactive environment. Where interactive display devices 8a and 8b have displays 10a and 10b, such displays devices can be used in such an embodiment to provide “player perspective” views of the interaction or to provide player information that is confidential to the player. In such an embodiment, a collectible display device 8c and 8d that is operated directly by the interaction module 60 can be adapted to provide information that is intended to be observable by both participants. Such an embodiment could also be operable in a single player mode wherein only one of display devices 8a and 8b are adapted to communicate with interaction module 60.

In another embodiment, any of the above-described features of interaction module 60 can be incorporated into one of the collectible display devices, e.g. collectible display device 8c with the other collectible display device 8d interacting therewith as described above.

It will also be appreciated that, in selected embodiments of collectible display device 8a and 8b shown in FIG. 5 a display driver 14 and source of power is not provided for each collectible display device 8. Such an approach can use a non-volatile type of display 10 to present image content. It is characteristic of a non-volatile display 10, that it allows images to be electronically written and electronically rewritten to non-volatile type of display 10. However, once written, the non-volatile type of display 10 maintains an appearance that is written thereon without requiring additional power input.

One popular embodiment of such a non-volatile type of display 10 is a bi-stable cholesteric display device. Such a non-volatile type of display 10 provides reflective picture elements that have at least two states and that can be transitioned from one state to at least one other state to form images. A non-volatile type of display 10 can comprise for example, a reflective passive-matrix display. Such reflective passive matrix displays can be employed because they do not require energy for light emission and are well-suited to low-cost control and manufacturing methods. One such display using bi-stable cholesteric materials is described in U.S. Pat. No. 5,437,811 entitled “Liquid Crystalline Light Modulating Device and Material” issued Aug. 1, 1995. Such displays can be made on flexible substrates and with low-cost roll-to-roll or continuous manufacturing methods thereby reducing cost and providing useful attributes in a collectible display application. Where such a nonvolatile type of display is used, interface module 60 can provide the necessary circuits and systems for writing images to a non-volatile type of display 10. In this way, each collectible display device 8 can be made inexpensively and in a form factor that can be conveniently collected and stored in a manner that is consistent with conventional practices.

In other embodiments of the invention, display 10 can be implemented with a variety of flat-panel display technologies, including full-color organic light emitting diode (OLED) displays or liquid crystal displays (LCDs) and appropriate drivers and power sources can be supplied in collectible display devices that operate such display types so that they can present images as required by a user.

The invention has been described in detail with particular reference to certain preferred embodiments thereof, but it will be understood that variations and modifications can be effected within the spirit and scope of the invention.

### Parts List

8 collectible display device
10 display
12a, b, c, d non-volatile memory
13a, b locking memory
14a, b, c, d display controller
16a, b display interface
18a, b memory interface
20a, b switch
22a, b external interface
24a, b external systems
26a, b communication transducer
28a, b access port
29a, b power cell
30 body
32a, b user input system
34a, b audio system
36 front of display
38 back of display
40 external circuitry
41 provide initial character data step
42 record initial character data step
44 new character data found step
45 provide additional character data step
46 record initial character data step
50 programming system
52 display
53 image
54 image
55 image
56 terminal
60 interface module
62 port
63 memory
64 port

1. A collectible display device comprising:
a) a display;
b) a non-volatile memory adapted to store at least one set of pre-determined character information depicting a character, said character information including character data and character image content;
c) a communication circuit adapted to receive predetermined character information; and
d) a display controller adapted to receive pre-determined character information from the communication circuit, to store the received pre-determined character information in the non-volatile memory so that changes cannot be made to the pre-determined character information without external authorization and to cause the display to present at least one image based upon the character information.

2. The collectible display device of claim 1, wherein the character image content includes at least one group of an image, a sequence of images, or a stream of image sequences.

3. The collectible display device of claim 1, wherein the image content depicting the character includes image content depicting sporting events.

4. The collectible display device of claim 1, wherein the communication circuit comprises a transducer for exchanging data using a wireless communication path.

5. The collectible display device of claim 1, wherein the communication circuit is adapted for communication by way of a physical communication path.

6. The collectible display device of claim 1, wherein the communication circuit is adapted to use a removable memory to exchange data with the other collectible display.

7. The collectible display device of claim 1, further comprising a user input system and wherein display instructions and content display selection or exchange are entered using the user input system.

8. The collectible display device of claim 1, wherein the communication circuit is adapted to communicate with said other display device using network interaction.

9. The collectible display device of claim 1, wherein the communication circuit is further adapted to exchange interaction data with another collectible device and wherein the display controller is further adapted to use the interaction data to determine image content for presentation on the display.

10. The collectible display device of claim 1, wherein the character information includes at least one of character identification, character attributes, and character accomplishments.

11. The collectible display device of claim 1, further comprising a user input system having a transducer for converting a user input action into a signal that can be used by the display controller to determine personalization information.

12. The collectible display device of claim 11, wherein at least some of the predetermined character information is personalized in accordance with the personalization data.

13. The collectible display device of claim 12, wherein the display controller is further adapted to cause the display to present questions relevant to a character and wherein answers to the questions are used to determine personalization data.

14. The collectible display device of claim 11, wherein the personalization data is used to identify the owner of the collectible display device.

15. The collectible display device of claim 1, wherein the display is a flexible display.

16. The collectible display device of claim 1, wherein the display is the approximate size of a playing card.

17. The collectible display device of claim 1, wherein the display is a flat-panel display.

18. The collectible display device of claim 1, wherein any of the non-volatile memory, the display controller, and the communication circuit are mounted on the display.

19. The collectible display device of claim 1, wherein the display is an OLED display.

20. The collectible display device of claim 1, wherein the image content is at least one of a motion image sequence, a still image, a group of still images and a stream of image information.

21. The collectible display device of claim 1, further comprising an audio system to generate audio signals based upon audio content stored in the non-volatile memory and display controller.

22. The collectible display device of claim 1, wherein the character information further comprises audio content and wherein the display further comprises an audio system adapted to generate sounds based upon the audio content received by the display device.

23. The collectible display device of claim 1, wherein the display is a passive-matrix display.

24. The collectible display device of claim 1, wherein the display is a reflective display.

25. The collectible display device of claim 1, wherein the display is a non-volatile display.

26. The collectible display device of claim 1, wherein the display is a color display.

27. The collectible display device of claim 1, wherein the display controller is a non-programmable state machine.

28. The collectible display device of claim 1, wherein the display controller comprises a non-programmable logic circuit.

29. A collectible display system comprising:
a plurality of collectible display devices each collectible display device having at least:
a display capable of forming images; and
a non-volatile memory having predetermined character data stored therein;
at least one source of character image content;
at least one source of character data;
a communication circuit adapted to exchange data between the plurality of collectible display devices; and
a display controller adapted to use the predetermined character data to determine character data for each of the plurality of collectible display devices, to select character image content from the source of character image content for presentation on each collectible display device based upon the character data determined for that collectible display device and to cause the character image content selected for each collectible display device to be presented on the display associated with that collectible display device,
wherein the display controller further causes the character data determined for each collectible display device to be stored in the non-volatile memory for that device so that changes cannot be made to the determined character data without external authorization.

30. The display system of claim 29, wherein the communication circuit and display controller are located in an interface module that is separate from the display devices.

32. The display system of claim 30, wherein the interface module comprises at least one of a personal computer, a video game console, a hand held computing device, a telephone system, an internet appliance and a device adapted to generate signals that are viewable on video monitor.

33. The display system of claim 30, wherein the display is a bi-stable display and wherein the display controller comprises a display driver for causing an image to be formed on the bi-stable display.

34. The display system of claim 30 wherein the non-volatile memory comprises at least in part a non-volatile display, and wherein the determined image content is stored on the non-volatile display.

35. The display system of claim 29, wherein each display device has interaction data stored therein and wherein the display controller is adapted to select images from the source of images based upon the interaction data.

36. The display system of claim 29, wherein each collectible display device has interaction data stored therein and with the display controller being adapted to adjust the interaction data during an interaction between the collectible display devices, and to determine character information based upon the adjusted interaction data.

37. The collectible display system of claim 32, wherein the communication circuit exchanges data between the collectible display devices and the display controller via a communication through a computer network.

38. The collectible display system of claim 29, wherein the character data and character image are stored within the collectible display devices at manufacture.

39. The collectible display system of claim 31, wherein the character associated with each collectible display device is selected by a purchaser.

40. The collectible display system of claim 29, wherein a kiosk vends collectible display devices having different characters selected by a purchaser.

41. The collectible display system of claim 40, wherein the kiosk vends collectible display devices having different prices based upon the character information associated with the collectible display device.

42. The collectible display system of claim 36, wherein the kiosk provides collectible display devices with characters having at least one of character image, character attributes, and personalization data determined at least in part based upon a price paid for the collectible display devices.

43. The collectible display system of claim 29, wherein the collectible display devices take a form factor that approximates conventional tradable cards.

44. The collectible display system of claim 29, wherein each collectible display device has a user interface to receive personalization data and wherein the display controller determines at least one of the character data, interaction data and character image based upon the received personalization data.

45. A collectible display device comprising:
a) a display;
b) a non-volatile memory having pre-determined character information stored therein with the predetermined character information including character data and at least one character image;
c) a communication circuit adapted to receive additional character information; and
d) a display controller adapted to receive character data and image content from the communication circuit and to cause the display to present the character data;
e) wherein the display controller is further adapted to store additional received character information in the non-volatile memory so that changes cannot be made to the character information without authorization.

46. The collectible display device of claim 45, wherein the non-volatile memory comprises a locking memory portion that can store the character information so that character information can only be added to the non-volatile memory when an appropriate authorization code is provided and wherein the display controller uses the authorization code to change character data and image content.

47. The collectible display device of claim 45, wherein the display controller is further adapted to store data in an encrypted form in a preferred form in the non-volatile memory and to present only data and image content that has been encrypted in the preferred form.

48. The collectible display device of claim 45, wherein the non-volatile memory is a write once memory such that character information be added to the non-volatile memory but such character data and image content cannot be removed from the non-volatile memory without authorization.

49. The collectible display device of claim 45, wherein communication circuit is adapted to exchange interaction data and the display controller is adapted to use the interaction data in providing the character image content.

50. The collectible display device of claim 45, wherein the communication circuit is adapted to exchange interaction data, wherein the display is a cholesteric display.

51. A method for operating a collectible display device having predetermined character data and image content stored therein, the method comprising the steps of:
detecting a source of character information having character data and character image content;
receiving character information including character data and character image content from the source; and
storing the received character information so that once stored, the received character information cannot be adjusted without external authorization.

52. The method of claim 51, wherein the detected source of character information comprises another collectible display device having other character information and further comprising the step of detecting user input requesting the collectible display device to exchange the predetermined character information for the other character information stored in the other collectible display device and further comprising the step of performing the exchange only where external authorization is received from the other collectible display device.

53. The method of claim 51, wherein the collectible display device is adapted to receive separate installments of character information, wherein the source of character information provides more than option of character information for each installment, and wherein the step of receiving the character information comprises selecting one of the options for use with each installment.

54. The method of claim 53, wherein each selected character information option is stored so that it cannot be changed without external authorization.

55. The method of claim 54, wherein comprising the step of executing an interaction between the collectible display device and another collectible display device.

56. The method of claim 55, wherein the success of a character in an interaction determines the interaction data stored in the collectible display device.

57. The method of claim 56, wherein the interaction data can be used to obtain additional character information to be received and stored by collectible display device.

58. The method of claim 51, wherein the source of character information includes group information such as group data and at least one group image, and the source of character data provides the group information to the display device when the display device has acquired character information for each member of the group.
